(19) United States
(12) Patent Application Publication
(10) Pub. No.: US 2012/0178070 A1
(43) Pub. Date: Jul. 12, 2012

(54) METHOD OF APPARATUS FOR AUTOMATICALLY ELICITING HEALTH RELATED INFORMATION AND ELECTION OF A WELLNESS PROGRAM

(76) Inventors: Benjamin C. Wiegand, Yardley, PA (US); Steven J. Catani, Athens, GA (US)

(21) Appl. No.: 13/180,714

(22) Filed: Jul. 12, 2011

Related U.S. Application Data
(60) Provisional application No. 61/364,822, filed on Jul. 16, 2010.

(51) Int. Cl. G09B 23/28

(52) U.S. Cl. 434/262

(57) ABSTRACT

This invention discloses methods and apparatus for providing an automated health assessment interview and collecting data commensurate with such interview. The interview may include video segments based upon input from user interactive devices presented to the user.

### FIELD OF USE

This invention describes an automated apparatus for conducting a health assessment with a user.

### BACKGROUND

Traditionally Corporate health promotion programs have varied but tend to low participation. Given the expense of these programs and the expected benefits, any reasonable means of improving participation would be advantageous.

An initial step in most health promotion programs is to assess an individual's current health status and suggest relevant wellness programs. This is typically done with an information gathering mechanism referred to as a Health Assessment (HA) or Health Risk Assessment (HRA). Healthcare providers or computer systems using this information and various predictive algorithms can then determine and suggest appropriate wellness programs. These are the collective range of programs that help an individual deal with an existing condition, minimize or prevent the onset of an expected condition, or improve one's health lifestyle. Here we define wellness programs as training, interventions or therapies. Wellness programs may be one or more of the following but not limited to: smoking cessation, weight loss, diabetes lifestyle, hypertension, safety, environmental risk, behavioral modification, diet, stress management, nutrition, fitness, life balance, depression, back pain, sleep, hearing, or productivity.

Within a corporate health program, it is typically the individual's responsibility to elect participation in a wellness program. It is often during, or soon after, an initial step of electing to participate in a wellness program that a person must commit time and possibly financial resources in order to proceed. Consequently, a large number of potential participants choose not to continue.

One known approach is to provide a “program enrollment specialist” to interact with a subject to assist the subject through stages of awareness and election. A specialist may invoke a model to help navigate and encourage a new enrollee through to program selection. For example, a specialist can convey to the subject that they are potentially vulnerable to a disease or condition or that the condition they have is threatening and convince the person that an intervention is efficacious and achievable by the user.

### SUMMARY

Accordingly, the present invention includes methods and apparatus to improve a proportion of potential candidate's participation in a wellness program. This is accomplished via the automation of an individual's health interview and the automated provision of guidance and encouragement to select one or more offered wellness programs based upon specific criteria associated with each respective candidate.

According to the present invention, a premise is adopted that in order to improve participation in one or more wellness programs, a potential user's behavior must be changed. The present invention creates automated processes based upon a logical rule that behaviors are the result of one or more of a user's beliefs, attitudes and preferences. Consequently, according to the present invention, getting a higher level of participation first requires an understanding of how to influence one or more of the user's beliefs, attitudes and preferences during the HA. Behavior modification is essentially approached via a model. Three exemplary models targeting behavior change that may be implemented in an automated program include: a) Health Belief Model (HBM); b) Stages of Change Model (SCM); and c) Consumer Information Processing (CIP).

The HBM model suggests two factors that determine whether a person will adopt the suggested course of action. First, the person must believe that they are potentially vulnerable and the condition is threatening. Secondly, the person must be convinced that the intervention is efficacious and perceive few barriers in taking the recommended action.

The SCM model suggests that individuals are at varying levels of readiness to change along a continuum of five stages. 1) Pre-contemplation—the individual is unaware of the problem or has no intention of engaging in behavioral change. 2) Contemplation—is the stage where people realize that they have a health concern, but have not committed to change. 3) Preparation—is the stage where the individual is considering changing behavior. 4) Action—is the stage where the individual implements the behavioral modification plan, and 5) Maintenance—the stage in which the individual continues the desired behavior.

The CIP model suggests that consumer decision-making is a multistage process in which information is acquired and processed, a decision is made and acted upon, and the quality of the decision is then evaluated. Of interest in this model is an individual's motivation to search and acquire information. Additionally, the model suggests that consumers make decisions in an irrational manner tending to rely on limited information and often ignore negative information if preconceived notions are followed.

However, for an automated wellness program enrollment system, the benefit of human assistance to influence behavior is lost. Typically, in an automated health assessment system, the data is entered, and then analyzed, and a prescriptive list of wellness programs suggested. An automated enrollment system relies solely on the individual to elect participation without benefit of enlightening or encouraging the user to enroll. Further, little is done in the HA process to influence attitudes, beliefs or preferences.

What is needed is a method by which a user, in the process of completing an automated HA, is provided the necessary and compelling information that helps them overcome reluctance and encourages election of one or more wellness programs.

### DESCRIPTION OF THE DRAWINGS

FIG. 1 illustrates a basic flow diagram of some aspects of the present invention.

FIG. 2 illustrates additional aspects of the present invention in a flow diagram.

FIG. 3 illustrates additional aspects of the present invention in a flow diagram.

FIGS. 4A-4C illustrate an example of an interactive video displayed on a computer system.

FIG. 5 illustrates exemplary apparatus that may be included in the present invention.

### DETAILED DESCRIPTION OF THE INVENTION

The present invention includes method and apparatus for providing to a user a video-based story with content to autonomously convey information and motivate the user. In addition, in some embodiments, the methods and apparatus include interactive video with branching capability directed to engaging an individual in the selection of one or more wellness programs. The use of interactive video with branching autonomously gathers information and facilitates the provision of information to inform and encourage users of the personal benefits of a healthier lifestyle.

The present invention combines electronic video storage and computer delivery to create interactive storylines, wherein a user is a participant in the video's story line and alternative segments to the story are seamlessly generated at the direction of the user. Accordingly, in interactive videos, a user can participate in a customized storyline that informs the user and motivates the user to provide information which is received and stored by automated apparatus.

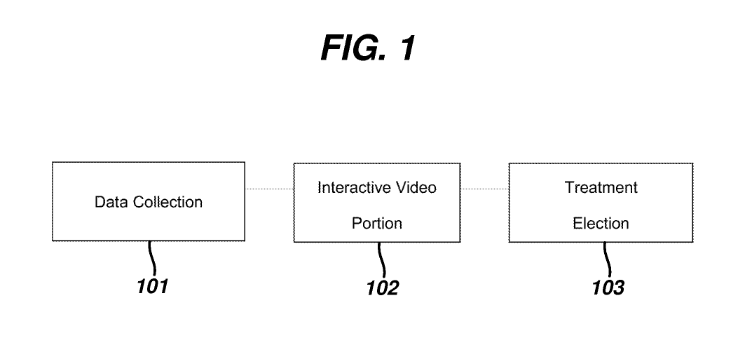

Referring now to FIG. 1, a flow chart illustrates three basic method steps that may be employed by the present invention. At 101 in a first portion, basic personal health information is collected. In addition, establishing any health concerns of the user may be received. The basic personal health information and data related to health concerns is stored as digital data. At 102, a second portion may include an interactive video portion specific to one or more health concerns of a user, wherein the interactive video portion educates and motivates the user in selecting one or more of a training, treatment or intervention program. At 103, a third portion of the method includes storing a record of the user's selection. The second portion 102 and the third portion 103 may be repeated for multiple stated health concerns of a user.

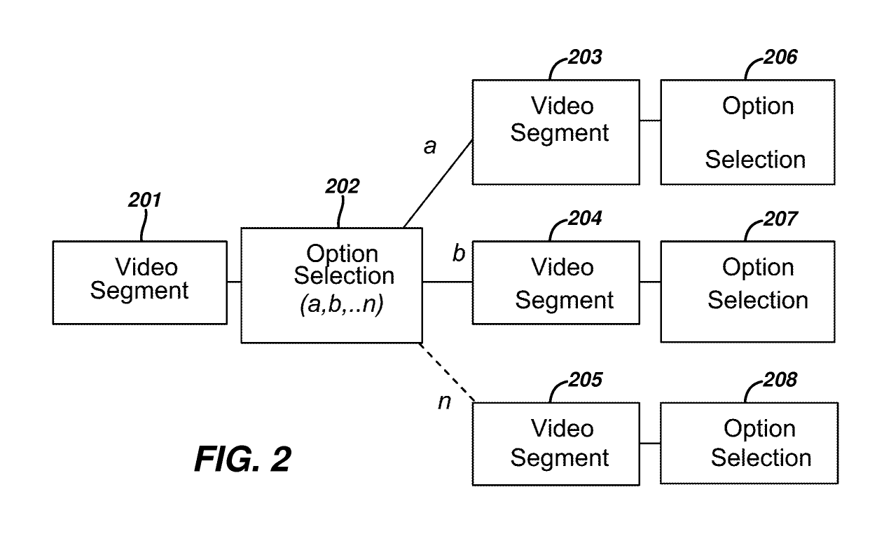

Referring now to FIG. 2, a video portion may include one or more video segments 201 followed by a user interactive offering. The interactive offering may include two or more options 202. Depending on an option 202 selected, a video may continue with subsequent video segments 203-205 in a script or return to a next step in the process, such as option selection 206-208. Options 206-208 offered by an automated HA system may include corresponding video segments that continue a storyline consistent with a user's data. At the completion of branches in a video sequence 201-208, the automated HA system process automated HA system return a user to a next portion of the method.

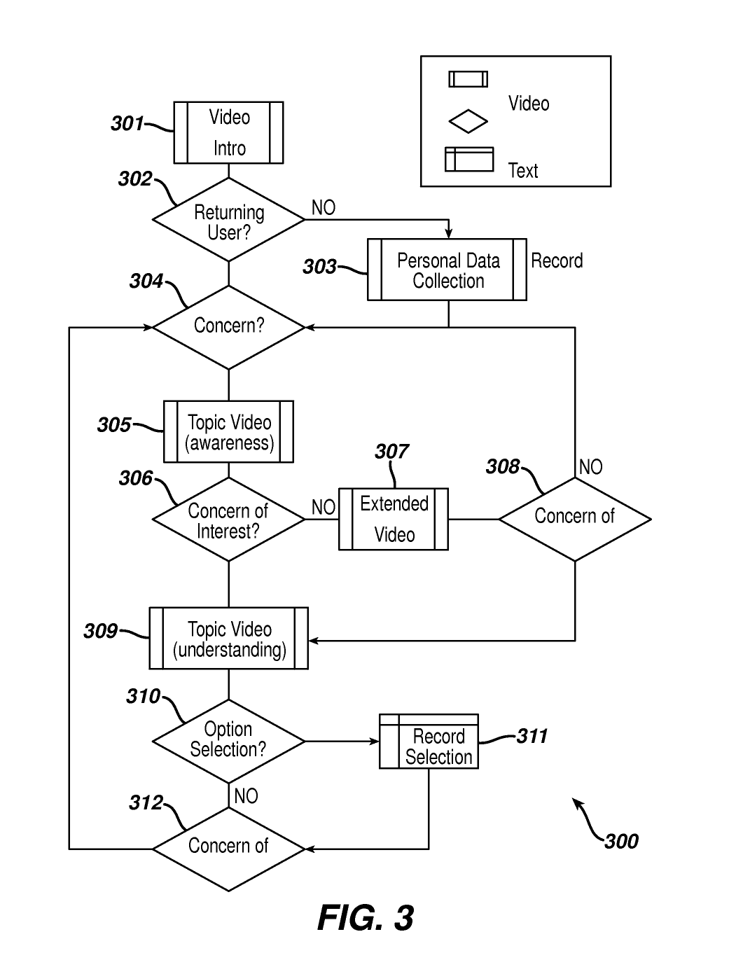

Referring now to FIG. 3, a more detailed flow of the overall video interview and program election process is illustrated. The process starts with a video introduction 301 providing for example, an overview of the system's objectives, rules and disclaimers and invites the user to participate. It is followed by a question 302, regarding if the user is a returning user—if so their personal data is already on file and if no changes are needed then this interview is skipped. If not, they are directed to an interactive video interview 303 to input personal health data.

The next step in the process is to establish a concern of the user. It should be noted that the system has established a list of possible concerns that the user might have based on their personal data. If the user has no immediate concerns, the system suggests possible concerns for the user to explore. In either case, the user is offered a menu of possible concerns for them to pick from 304. Once a topic is selected, for example weight loss, then the system provides an interactive Topic Video storyline 305 in which the user may be a first person participant. This portion is to establish the level of awareness the user has for the topic. Nested within this module is a topic specific storyline that helps make the user aware of the issues surrounding their concern, such as weight loss. For example, if the user is a young person, the storyline may depict what happens if only a couple pounds are added each year and the cumulative effect of overweight in the later years making them aware of compounding weight.

Once this first portion of the video has played out, the system inquires if the topic covered is resonant with the user's concern 306. Note that the system starts with the most likely issues related to the expressed concern. If not, the system starts an ‘extend video’ 307 discussion of some of the less frequent issues. In our example, a sudden weight gain may be the issue and not one of long-term weight gain as is more frequently the case. After reviewing possible subtopics, the system again asks the user if this is their concern 308. If not, the system takes them back to the first concern option point 304 to explore other possible concerns. If yes, then the system takes the user to the next step in the process to expand on the topic.

The second Topic Video 309 is an interactive video to establish understanding and benefit of the training, treatment and intervention programs available. It may deal with common misconceptions of these options; or it may deal with detailed explanation of what happens in the program to establish familiarity and comfort. In this way, the user is more likely to select and pursue the proposed wellness program.

Once the second Topic Video is completed, the system directs the user to select one or more wellness program options available to them 310. This is recorded and transmitted appropriately to those responsible for enrolling the user in the program 311. The system then asks if there are additional user concerns and provides the user a means to log off the program or continue with an additional concern 312.

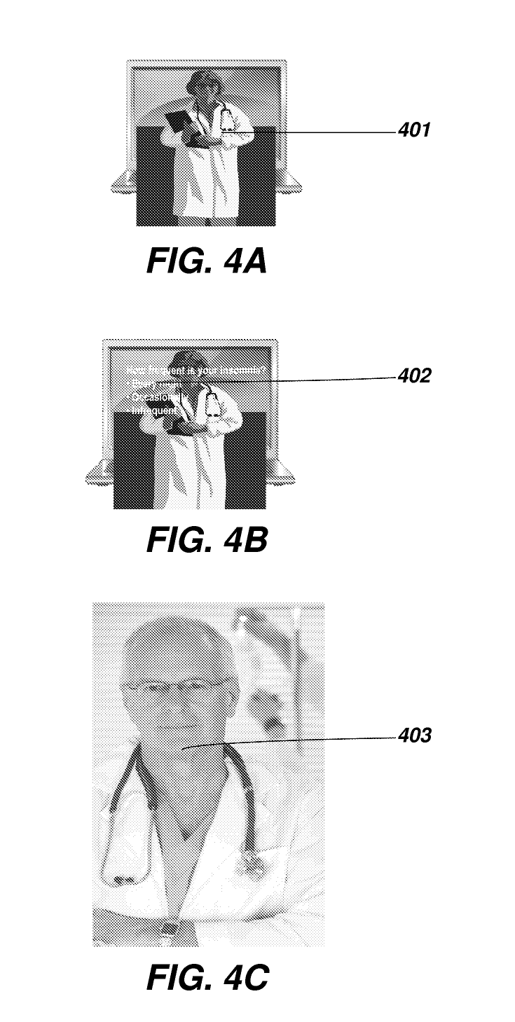

Referring now to FIGS. 4A-4C, scenes from an interactive video interview are illustrated. An introduction 401 may include general questions related to the patient and health status. Video segments directed to a particular set of circumstances 402 may follow the general introduction. In some instances video segments of a doctor 403 may be spliced in to conduct a virtual interview of a user and be based upon particular information provided by the user. In some embodiments, an interview may include one or more breakpoints where the user is asked with text to select one of several possible answers.

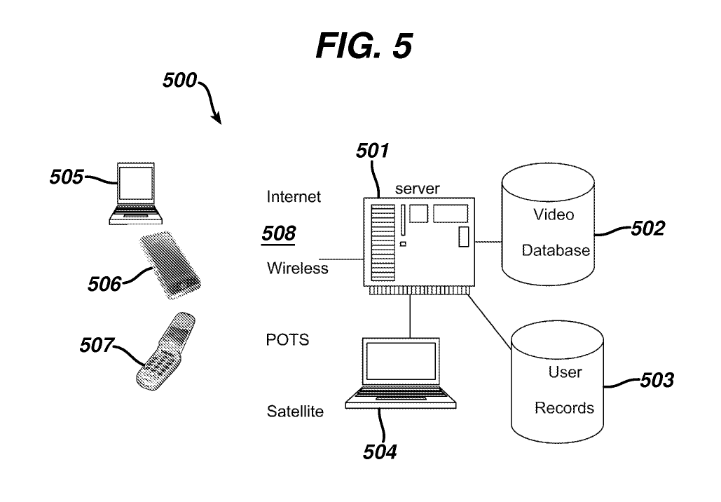

Referring now to FIG. 5 an exemplary configuration of the hardware used in the control, delivery and record of health interviews and wellness program selection is illustrated. While the system may be implemented as a standalone platform, it is preferred to be a networked system 500. The server 501 contains information pertinent to each corporate client including the wellness programs offered. The server accesses and updates the database of informational data for users 503 and provides appropriate backup. The server also has access to a database of all video segments 502 used in the video interview. The system can be accessed by any network access device 505-507 capable of receiving and transmitting data interactively over a distributed network 508. This would include stationary computers, game systems, and mobile devices such as cell phones, e-book readers such as Amazon's Kindle® or Barnes and Noble's Nook®, or Apple's iPod or iPad®. Video segments can then be streamed to the device or loaded onto the device for viewing. The user can log into a user account and access various interview programs available.

A network diagram illustrating one embodiment of the present invention is shown. An automated HA system can include a computerized server 501 accessible via a distributed network 508 such as the Internet, or a private network. A risk information source can also include a computerized server 501. A user can use a computerized system or network access device to receive, input, transmit or view information processed in the HA system, a peer device, or other network access device. A protocol, such as, for example, the transmission control protocol internet protocol (TCP/IP) can be utilized to provide consistency and reliability.

A system access device can communicate with the HA system to access data and programs stored at the respective servers. A system access device may interact with the HA system as if the servers were a single entity in the network. However, the HA system and risk information source system 402 may include multiple processing and database sub-systems, such as cooperative or redundant processing and/or database servers that can be geographically dispersed throughout the network.

A server utilized in a HA system can include a processor, memory and a user input device, such as a keyboard and/or mouse, and a user output device, such as a display screen and/or printer. A server can also include one or more databases storing data relating to a security risks or elements. Information relating to elements and/or security risks or other threats can be aggregated into a searchable data storage structure. Gathering data into an aggregate data structure, such as a data warehouse, allows a server to have the data readily available for processing. Aggregated data may also be scrubbed or otherwise enhanced to aid in searching.

Typically, an access device will access an HA system using client software executed at the system access device. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from a server to the system access device and executed at the system access device. Other implementations include proprietary software installed from a computer readable medium, such as a CD ROM. The invention may therefore be implemented in digital electronic circuitry, computer hardware, firmware, software, or in combinations of the above.

In addition, a controller that is descriptive of the access devices shown, for example, in FIG. 5 according to some embodiments of the present invention may include one or more processors, coupled to a communication device configured to communicate via a communication network. The communication device may be used to communicate, for example, with one or more network access devices.

The processor is also in communication with a storage device. The storage device may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device can store a program for controlling the processor. The processor performs instructions of the program, and thereby operates in accordance with the present invention. For example, the processor may receive information descriptive of an HA. The processor may also transmit information.

The illustration and accompanying description of the HA related database presented herein is exemplary, and any number of other database arrangements can be employed besides those suggested by the figures.

In a preferred embodiment, an automated health interview and program selection system includes apparatus and software to provide an interactive user interface operative to conduct an automated interview that includes an interactive video story line that causes the user to supply background information The interview may include two or more sequential steps including; data input, addressing the concern, and wellness program selection.

In some embodiments, the system ends this first section with an inquiry regarding any health concerns the user has. The user's response to this question, if in the affirmative, causes an additional interactive video sequence that engages the user in a storyline that provides descriptive information of the concern. The additional interactive video sequence may be completed with a question if the user acknowledges that a concern depicted and explained is one that the user has.

If the user's response to this question is affirmative, still another interactive video sequence may be provided to give the user a deeper understanding of the condition and to review remedial programs that are available. At the end of this third sequence, the user is asked to select a wellness program designed to help them address their concern. Once the election is made, a record of the selection is sent to an appropriate receiver for including the user in a wellness program.

Interactive video permits stories to unfold with periodic requests for user input including providing personal health information. This information is used by the system to select subsequent video sequences and is recorded as data in the user's personal file. In some embodiments of the present invention, a storyline includes a virtual visit to a health care provider, such as, for example, a virtual doctor.

The virtual doctor may provide an introduction and discussion on a particular topic. The virtual doctor may ask a question of the user (in either verbal/audible form) and the user may respond in a like format. An answer provided may be utilized to cause the system to select a subsequent video scene with the doctor continuing a line of questioning consistent with the user's answer to one or more of the prior questions.

The present invention uses one or more interactive video storylines to provide informative and emotive scenes that help the user understand, at a visceral or behavioral level, the ramifications of poor behavior. For example, the use of cigarettes can be depicted as part of a scene where the user takes on the role of the spouse of a person dying of lung cancer and discussing the benefits of having quit smoking earlier in life. A user is more likely to sign up for a smoking cessation program after role-playing such a scene.

Technical or complex questions in a health assessment interview often confuse people. According to the present invention, a video scene of a doctor explaining symptoms or showing an animated graphic helps users to better understand their condition as compared to a text message. The use of video segments also results in more accurate answers. For example, the question “Do you have a high frequency hearing loss?” is better understood if the scene portrays an audiologist asking if the user has a harder time understanding female voices vs. men's voices or even demonstrating this using male and female actors.

HA forms can be frustrating and tedious in that they are difficult to follow, especially with instructions for jumping over questions immaterial to the particular user. With branching video, those questions that are immaterial are automatically skipped. This speeds the interview process and minimizes frustration. In addition, if a user has already used the system and completed their background information, that portion is skipped. The video storyline can then jump to a theme of more immediate concern to the individual. With input from the user, the system can focus on a particular concern with a storyline addressing the immediate issue and the user offered relevant wellness programs. Frustratingly, automated text-based health assessment programs commonly require that all information be inputted before wellness programs can be offered.

In some embodiments, automated health interview and program selection systems may be used in one or more predetermined groups of users, such as for example corporate health wellness programs, or health plan enrollees, to assist the employees or enrollees electing to participate in wellness programs. Each company may have a customized set of offerings of particular wellness programs available to its employees; other groups of users may also have predetermined offerings. Accordingly, in some embodiments, only specified offerings of a particular company are made available to the company's employees.

Unlike static programs used in the past wherein a user may elect programs that may have immediate interest to them, the present invention provides to a user in a user understandable form, a list of one or more suggested wellness programs that are relevant to a user based upon data collected pertaining to the user. In some instances, the present invention may suggest a program that was not a concern of the user prior to the automated health assessment. In some exemplary embodiments, the system may determine that a user is likely to be interested in a program based on age, gender, personalized data or other information provided to the automated system.

The present invention may also utilize classification algorithms that use the data from an HA to predict the probability that a person may have or will have a condition. Moreover, for some conditions, appropriate intervention may delay or eliminate the person's risk. For example, if a person reports their age, weight and height and it is determined that the person is obese, then the system will suggest that the user engage in a storyline to help establish awareness and understanding of the effects of long-term obesity and to offer appropriate weight reduction programs.

This method can be delivered through a networked system such as the internet or isolated and stored on a permanent data storage medium. The system can have local storage of video, distributed video or streaming video from a remote server. The system can be expanded or updated with the introduction of new scenes and the software logic to access those scenes. For example, if there is a high incidence or need to address H1N1 flu symptoms, a video depicting the symptoms and available wellness programs can be inserted into the library of video segments. The concern of H1N1 flu is then inserted as one of the possible topics the user can pick from.

To implement this system, video sequences may be predefined and produced. Video sequences may be of live actors or computer generated characters or avatars. Generally, live actors are preferred for maximal effect; however, computer generated images may be produced at substantially lower cost. Producing a script requires considerable thought and creativity. Each question in a line of questioning must be prerecorded as a video segment. An interactive HA interview can be developed by producing a script, collecting or creating content (video, computer graphics or text) based on the script, formatting the content for local or stand-alone processing or formatted for a networked environment using a Rich Internet Application (RIA) and then publishing the content. Formatting the content for local or internet delivery may be accomplished via software applications such as Adobe's Director and a runtime application such as Adobe AIR.

The user can interact with the system by various input means. The most obvious is for a user to operate a control apparatus such as, for example, one or more of: a keyboard, a mouse, a pointing device, a touch screen, voice control device, to be connected to the computer system. When a series of options are presented, the user may select a preferred answer with a corresponding user operation, such as, for example, a keystroke, a mouse click, a screen touch or other action.

A programmable user interactive device may include a virtual button, check box, alphanumerical input, or other user definable selection via a human readable interface.

In some embodiments, interactive automated HA apparatus may include audio apparatus and microphone capabilities. In such instances, input may include verbal communication that is detected and interpreted by speech recognition software such as Naturally Speaking from Nuance. Other auxiliary input devices may also be used to make a selection, including, for example, a tilt function on an iPod or a mouse or a hand controller as used in the Nintendo Wii system.

In a corporate environment, it may be beneficial to know who has completed a health history and wellness program selection. A goal of some organizations or groups may include encouraging employees to use HA systems and track a number of people who have completed enrollment. Therefore, in some preferred embodiments, an automated HA system is deployed over a network where enrollment can be monitored and a database of user input maintained. Networked systems are also helpful in tracking who has signed up for what program.

### ILLUSTRATIVE EXAMPLE

### Healthcare Practitioner Interview

An illustrative example of an interactive video HA program with wellness program election is a storyline of a patient visiting their primary care healthcare practitioner. The opening scene may include a health care practitioner, such as a doctor wherein the healthcare practitioner asks that a user provide aspects of personal information.

A clipboard may also appear with interactive portions for the user to insert information such as: name, address, and physical data such as height, weight, age. When the input of information is completed, the scene may return to the health care practitioner. A scene may also select from several alternatives based on the user's attributes such as, by way of non-limiting example, the user's: gender, age, physical condition, weight, symptoms, or preference. For example, if the user's preference is to interact with a virtual female doctor then the scene will open with greetings from a female doctor. Subsequent inquiries by the virtual doctor will be a sequence of discussions or questions that are age and gender relevant.

Each video sequence will have the health care practitioner inquiring into the health and concerns of the user. For example, the health care practitioner may introduce the topic of stress management. A virtual discussion may ensue including what stress management is, how it is manifested, and how it affects health.

The health care practitioner concludes with a question regarding the user's interest in learning more about stress management. The screen then shows a graphic of possible answers such as: 1) would like to know more about stress management, 2) would like to see a professional for possible interventions, or 3) not interested. At that point, the system captures the user's response and selects the appropriate next scene. If the user would like more information, then the next scene may be of a specialist in stress management introducing herself and discussing the symptoms and possible treatments of stress. If the user prefers to see a professional for training or intervention, then a next scene may show a specialist in stress management discussing the types of programs available. In both cases the professional addresses possible biases, benefits of available programs and encourages the user to participate. If the person was not interested, then the next video would give the user ability to log off or continue with another concern. At the completion of this second video, the person will be aware of the issues and understand in more detail what options are available. At the end of a second video segment, another option page may be shown providing a user an opportunity to participate in one of multiple available wellness programs being offered.

### EXAMPLE 1

### Grocery Shopping

For many people trying to lose weight a wellness program on nutrition may be appropriate. This interactive video sequence helps to identify what foods a shopper may select in a typical visit to the grocery store.

It may be boring and tedious to ask a person to review a list of nutritional items, such as foods and supplements that the user may typically select on a trip to the grocery store. An interactive video interview with branching may provide the ability to have a user participate in a virtual trip to the grocery store and is more engaging. Moreover, it is visually stimulating and provides more accurate behavioral responses, a process difficult to replicate in a text based system and more realistic to the user.

Through such a video storyline, the user can experience virtual food shopping emulating walking down a virtual store aisle and selecting food and supplement items of interest to the user. In some embodiments, the user may choose which aisles to virtually go down. The system branches to a video showing various products found in the aisle of choice.

By seeing food products, the user can then make a buying decision through, for example, a verbal command or a key stroke. The system has a look-up table of what food item is being shown when the user indicates intent to purchase. In this manner the software can log products the user intends to purchase. The software can then catalogue the food items and look up their nutritional and fat content.

In a different aspect, in some embodiments, after a virtual shopping is at least partially completed, an interactive video segment may present to the user a nutritional advisor, such as a nutritionist. The nutritional advisor may review dietary implications of the user's purchasing decisions. The system may select from say three or more possible scenes based on an analysis of the user's food preferences being of poor, average or healthy choices. Based on the review, the virtual nutritionist may describe the benefits of an offered nutrition wellness program and then encourage the user to sign up.

### CONCLUSION

In the sections above, detailed descriptions of some embodiments of the invention have been given. The description of both preferred and alternative embodiments are exemplary embodiments only, and it is understood that to those skilled in the art that variations, modifications and alterations may be apparent. It is therefore to be understood that said exemplary embodiments do not limit the scope of the underlying invention, as described above and as further defined by the claims below.

1. Automated apparatus to facilitate a health assessment interview with a user, the automated apparatus comprising:
a server comprising a processor and a storage for digital data; and
executable software stored on the storage for digital data and executable on demand, the software operative with the processor to cause the apparatus to:
transmit an interactive video to a network access device associated with the user;
receive data associated with the user and descriptive of personal health information and preference data from the user;
transmit data descriptive of multiple health concern topics;
receive data indicative of a user selected health concern topic;
transmit a first video segment of a health related storyline based on the user selected health concern topic;
pause the first video segment with a predefined breakpoint;
provide user selectable interactive devices for inputting options to elicit information from the user;
receive additional data associated with the user and descriptive of personal health information, wherein the additional data is based upon queries presented in the first video segment;
transmit a second video segment that provides a review of wellness program options available to the user and related to the data associated with the user and descriptive of personal health information; and
record at least one selected option input via a user interactive device the user.

2. The apparatus of claim 1 wherein more than two video segments and options are transmitted to the network access device associated with the user.

3. The apparatus of claim 1 wherein the wellness program options available to the user are based upon a database of possible options and limited to a set of options a defined entity offers its members.

4. The apparatus of Claim 1 wherein a record of a program selection by a user is automatically transmitted to a network device associated with an entity responsible for enrolling the user in a program.

5. The apparatus of claim 1 wherein the health concern comprises a subset of possible concerns based on a user's age, gender, behaviors, existing health conditions, and preexisting familial conditions.

6. The apparatus of claim 1 wherein user selectable interactive devices comprise a programmable icon.

7. The apparatus of claim 1 wherein user selectable interactive devices comprise a programmable checkbox.

8. The apparatus of claim 1 wherein user selectable interactive devices comprise a programmable drop down list.

9. The apparatus of claim 1 wherein the software is additionally operative to cause a video image of nutritional advisor providing advice based upon input of a user's food preferences.

10. The apparatus of claim 9 wherein the nutritional advisor describes benefits of virtual nutrition wellness program.
